(19) United States
(12) Patent Application Publication
(10) Pub. No.: US 2025/0272906 A1
(43) Pub. Date: Aug. 28, 2025

(54) TRUE ORTHOIMAGE GENERATION APPARATUS AND METHOD

(71) Applicant: DABEEO, INC., Seoul (KR)

(72) Inventors: Juhum Park, Bucheon-Si (KR); Jang Hoon Hwang, Seoul (KR)

(73) Assignee: DABEEO, INC., Seoul (KR)

(21) Appl. No.: 18/923,541

(22) Filed: Oct. 22, 2024

(30) Foreign Application Priority Data
Feb. 27, 2024 (KR) 10-2024-0028274

(51) Int. Cl. G06T 15/00; G06T 5/50

(52) U.S. Cl. CPC G06T 15/00; G06T 5/50; G06T 2207/20221

(57) ABSTRACT

The true orthoimage generation apparatus of the present invention includes a processor and a memory configured to store instructions executed by the processor, wherein the processor acquires a point cloud from a plurality of superimposed aerial images through neural radiance field inference, derives a plurality of local true orthoimages showing a vertical view of the point cloud, and then generates a true orthoimage using the local true orthoimages.

### CROSS-REFERENCE TO RELATED APPLICATION

This application claims priority to and the benefit of Korean Patent Application No. 10-2024-0028274, filed on Feb. 27, 2024, the disclosure of which is incorporated herein by reference in its entirety.

### BACKGROUND

### 1. Field of the Invention

The present invention relates to a true orthoimage generation apparatus and method.

### 2. Discussion of Related Art

True orthoimages (true orthophotos) are vertical images generated by minimizing distortion caused by changes in height of terrain features using a digital surface model among images that provide a user with a view similar to what the user would see from above in a vertical direction.

That is, a true orthoimage is an image that is converted from aerial photographs taken by aircraft such as a drone, an airplane, or a satellite into an image that shows all objects when the objects are viewed from above in a vertical direction by correcting geometric distortion information caused by rises and drops terrain, such as height differences and inclinations.

True orthoimages are being produced and utilized in many fields because it is possible to obtain various types of information, such as distance, location, area, etc. with respect to terrain features.

The related art of the present invention is disclosed in Korean Laid-Open Patent Publication No. 10-2011-0082903 (Jul. 20, 2011) “Method of compensating and generating orthoimage for aerial-photo.”

### SUMMARY OF THE INVENTION

The present invention is directed to providing a true orthoimage generation apparatus and method that are capable of acquiring a point cloud from a plurality of superimposed aerial images, deriving local true orthoimages showing a vertical view of the point cloud, and then generating a true orthoimage by connecting the local true orthoimages.

According to an aspect of the present invention, there is provided a true orthoimage generation apparatus, which includes a processor and a memory configured to store instructions executed by the processor, wherein the processor acquires a point cloud from a plurality of superimposed aerial images through neural radiance field inference, derives a plurality of local true orthoimages showing a vertical view of the point cloud, and then generates a true orthoimage using the local true orthoimages.

The processor may derive the point cloud using an artificial intelligence model for the neural radiance field inference and perform view synthesis on the point cloud to be viewed at continuous angles.

The artificial intelligence model may learn the superimposed aerial images and a transformation extrinsic matrix that transforms points within a camera from the superimposed aerial images into a world coordinate system.

The processor may arrange the plurality of virtual cameras that photograph the point cloud and acquire the local true orthoimages for each virtual camera.

The virtual cameras may be arranged at preset intervals at positions perpendicular to the point cloud.

Information related to direction and distance about the point cloud may be set for the virtual cameras.

The information related to direction may include at least one of an angle formed by the virtual camera and a YZ plane of the point cloud and an angle formed by the virtual camera and an XY plane of the point cloud.

The processor may generate the local true orthoimages at set patch intervals using the virtual cameras and acquire the true orthoimages by connecting the local true orthoimages generated at the set patch intervals.

According to another aspect of the present invention, there is provided a true orthoimage generation method, which includes acquiring, by a processor, a point cloud from a plurality of superimposed aerial images through neural radiance field inference, deriving, by the processor, a plurality of local true orthoimages showing a vertical view of the point cloud, and generating, by the processor, a true orthoimage using the local true orthoimages.

In the acquiring of the point cloud through the neural radiance field inference, the processor may derive the point cloud using an artificial intelligence model for the neural radiance field inference and perform view synthesis on the point cloud to be viewed at continuous angles.

The artificial intelligence model may learn the superimposed aerial images and a transformation extrinsic matrix that transforms points within a camera from the superimposed aerial images into a world coordinate system.

In the deriving of the plurality of local true orthoimages, the processor may arrange a plurality of virtual cameras that photograph the point cloud and acquire the local true orthoimages for each virtual camera.

The virtual cameras may be arranged at preset intervals at positions perpendicular to the point cloud.

Information related to direction and distance about the point cloud may be set for the virtual cameras.

The information related to direction may include at least one of an angle formed by the virtual camera and a YZ plane of the point cloud and an angle formed by the virtual camera and an XY plane of the point cloud.

In the generating of the true orthoimages, the processor may generate the local true orthoimages at set patch intervals using the virtual cameras and acquire the true orthoimage by connecting the local true orthoimages generated at the set patch intervals.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram of a true orthoimage generation apparatus according to an embodiment of the present invention;

FIG. 2 is a set of diagrams of exemplary aerial images according to an embodiment of the present invention;

FIG. 3 is a diagram of an exemplary point cloud according to an embodiment of the present invention;

FIG. 4 is a diagram showing an example of the arrangement of virtual cameras according to an embodiment of the present invention;

FIG. 5 is a diagram of an exemplary virtual camera and its local true orthoimage according to an embodiment of the present invention;

FIG. 6 is a diagram showing a plurality of virtual cameras arranged on a point cloud according to an embodiment of the present invention;

FIG. 7 is a diagram showing an example of an arrangement of local true orthoimages according to an embodiment of the present invention;

FIG. 8 is a diagram of an exemplary true orthoimage according to an embodiment of the present invention; and

FIG. 9 is a flowchart of a true orthoimage generation method according to an embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, a true orthoimage generation apparatus and method according to embodiments of the present invention will be described in detail with reference the accompanying drawings.

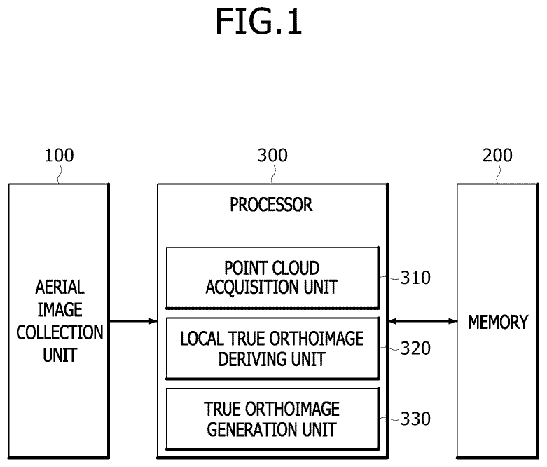

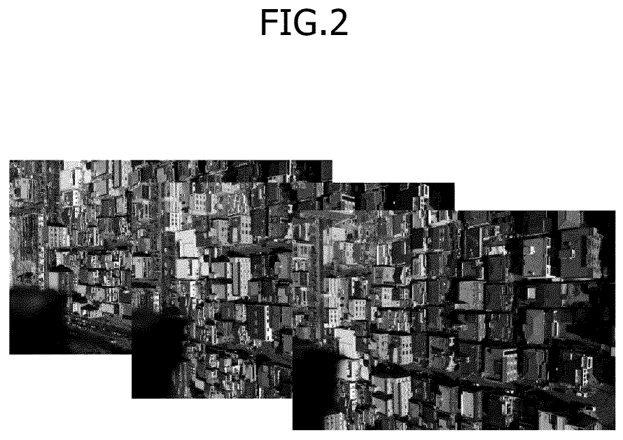

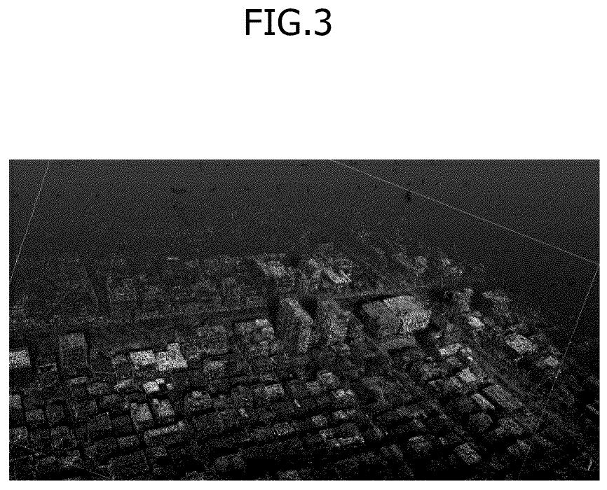

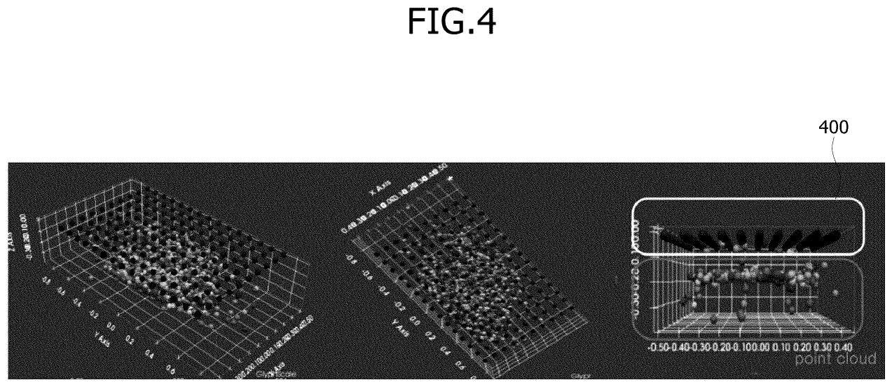

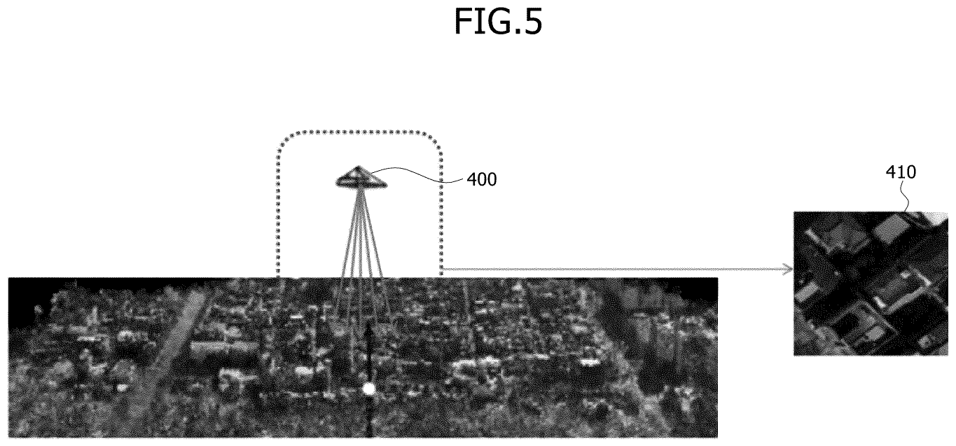

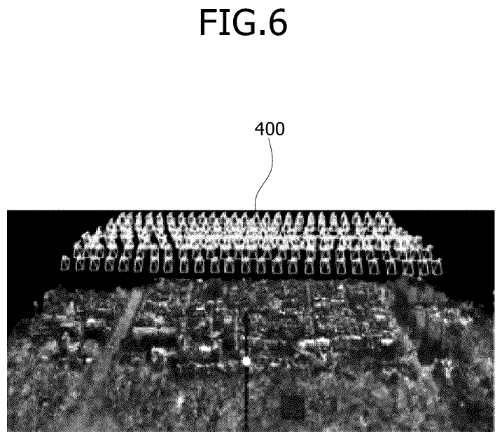

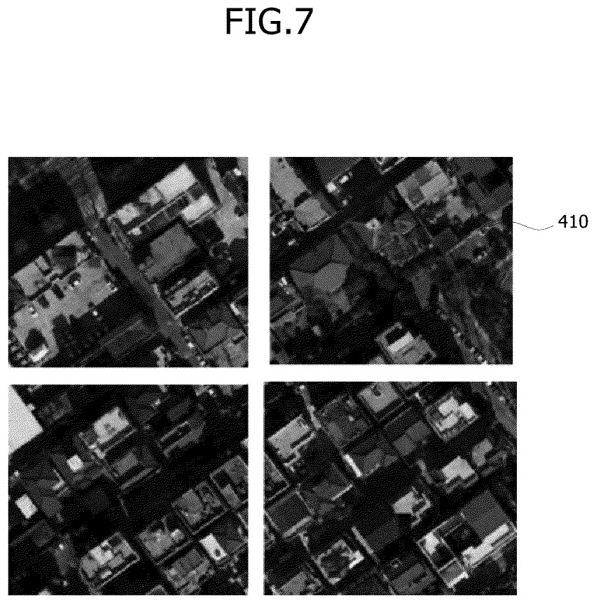

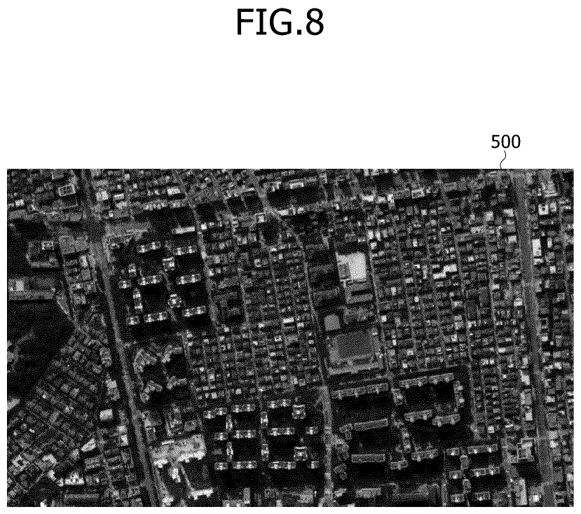

FIG. 1 is a block diagram of a true orthoimage generation apparatus according to an embodiment of the present invention, FIG. 2 is a set of diagrams of exemplary aerial images according to the embodiment of the present invention, FIG. 3 is a diagram of an exemplary point cloud according to the embodiment of the present invention, FIG. 4 is a diagram showing an example of the arrangement of virtual cameras according to the embodiment of the present invention, FIG. 5 is a diagram of an exemplary virtual camera and its local true orthoimage according to the embodiment of the present invention, FIG. 6 is a diagram showing a plurality of virtual cameras arranged on a point cloud according to the embodiment of the present invention, FIG. 7 is a diagram showing an example of the arrangement of local true orthoimages according to the embodiment of the present invention, and FIG. 8 is a diagram of an exemplary true orthoimage according to the embodiment of the present invention.

Referring to FIG. 1, the true orthoimage generation apparatus according to the embodiment of the present invention may include an aerial image collection unit 100, a memory 200, and a processor 300.

The aerial image collection unit 100 may collect aerial images.

The aerial images may be used for generating a true orthoimage 500 and may be images superimposed on the ground surface area.

The aerial images may be images of the ground surface area that are captured by photographing devices, such as a digital camera, aerial lidar, etc., from satellites, drones, aircraft, etc.

The aerial images may be used in various fields, such as navigation services, weather forecasting, land management, disaster monitoring, national security, marine water resource management, etc.

The aerial image collection unit 100 may be any of various devices for capturing or collecting aerial images, or a communication interface for collecting aerial images.

For example, the aerial image collection unit 100 may be a photographing device that captures aerial images.

The aerial image collection unit 100 may be a device that collects aerial images in real time from the above-described photographing device through a communication network.

The aerial image collection unit 100 may be a communication interface that collects aerial images through a communication network via a database unit (not shown) or a data storage unit (not shown) for storing aerial images.

The communication network may be a 3rd Generation Partnership Project (3GPP) network, a long-term evolution (LTE) network, a 5th generation (5G) network, a World Interoperability for Microwave Access (WiMAX), a wired or wireless Internet, a local area network (LAN), a wireless LAN, a wide area network (WAN), a personal area network (PAN), Bluetooth, Wireless Fidelity (Wi-Fi), etc., but the present invention is not particularly limited thereto.

The memory 200 may store various types of data used by the processor 300.

Instructions that allow operations or steps according to the embodiment of the present invention to be performed may be stored as the data. The memory 200 may store instructions for generating a true orthoimage 500 using a plurality of superimposed aerial images.

The memory 200 may store aerial images, local true orthoimages 410, or data that are required to generate the true orthoimage 500 in the processor 300.

The memory 200 may store an artificial intelligence model that is required to generate the true orthoimage 500 and data that is input to or output from the artificial intelligence model in the processor 300.

The memory 200 may also store the true orthoimage 500 generated by the processor 300.

The memory 200 may include at least one storage medium among a flash memory type memory, a hard disk type memory, a multimedia card micro type memory, a card type memory, a random access memory (RAM), a static RAM (SRAM), a read-only memory (ROM), a programmable ROM (PROM), an erasable programmable ROM (EPROM), and an electrically erasable programmable ROM (EEPROM).

The processor 300 may be connected to the memory 200 and execute the instructions stored in the memory 200. The processor 300 may execute the instructions stored in the memory 200 to control at least one other component (e.g., a hardware or software component) connected to the processor 300 and perform processing or operation on various types of data.

Further, the processor 300 may have components for performing each function that are differentiated at a hardware, software, or logic level. In this case, dedicated hardware for performing each function may be used. To this end, the processor 300 may be implemented as or include at least one of an application-specific integrated circuit (ASIC), a digital signal processor (DSP), a programmable logic device (PLD), a field programmable gate array (FPGA), a central processing unit (CPU), a microcontroller, and/or a microprocessor.

The processor 300 may be implemented as a CPU or a system on chip (SoC), control a plurality of hardware or software components connected to the processor 300 by driving an operating system or an application, and perform processing and operation on various types of data. The processor 300 may be configured to execute at least one instruction stored in the memory 200 and store data of a result of the execution in the memory 200.

The processor 300 may acquire a point cloud from a plurality of superimposed aerial images through neural radiance field inference.

The processor 300 may derive the local true orthoimages 410 showing a vertical view of the point cloud and generate the true orthoimage 500 by connecting the local true orthoimages 410.

The processor 300 may include a point cloud acquisition unit 310, a local true orthoimage deriving unit 320, and a true orthoimage generation unit 330.

The point cloud acquisition unit 310 may generate a point cloud using aerial images collected by the aerial image collection unit 100.

The aerial images may be superimposed images acquired by photographing the same ground surface area.

Referring to FIG. 2, the aerial images collected by the aerial image collection unit 100 may be a plurality of aerial images acquired by photographing the same ground surface area at multiple angles.

The point cloud acquisition unit 310 may generate a transformation extrinsic matrix that transforms points within a camera from each aerial image into a world coordinate system. Therefore, the transformation extrinsic matrix may be generated for each aerial image.

The point cloud acquisition unit 310 may acquire a point cloud using an artificial intelligence model for neural radiance field inference.

The point cloud acquisition unit 310 may learn the artificial intelligence model for the neural radiance field inference when the aerial images are collected.

The artificial intelligence model for the neural radiance field inference may learn after receiving input of the transformation extrinsic matrix and the aerial images and output a point cloud for neural radiance field inference as a result of the learning.

That is, the artificial intelligence model may learn the transformation extrinsic matrix and the aerial images every time the aerial images are collected and output the point cloud for neural radiance field inference.

In this case, the point cloud acquisition unit 310 may perform view synthesis on the point cloud generated through the artificial intelligence model to acquire a point cloud that allows the ground surface area to be viewed continuously at multiple locations and in multiple directions, thereby obtaining an effect of photographing the ground surface area at multiple locations and in multiple directions.

In FIG. 3, a point cloud acquired through a view synthesis technique is shown, and accordingly, a point cloud of the ground surface area may be acquired at multiple locations and in multiple directions.

The local true orthoimage deriving unit 320 may acquire local true orthoimages 410 showing a vertical view of the point cloud.

To this end, the local true orthoimage deriving unit 320 may arrange a virtual camera 400 to show a vertical view of the point cloud.

The virtual camera 400 may generate view images showing a vertical view of the point cloud.

Referring to FIG. 4, the local true orthoimage deriving unit 320 may arrange a plurality of virtual cameras 400 to show a vertical view of the point cloud.

The local true orthoimage deriving unit 320 may arrange the virtual cameras 400 to be coplanar.

The local true orthoimage deriving unit 320 may arrange the plurality of virtual cameras 400 at set intervals. For example, the information related to direction and distance about the point cloud may be set for the virtual cameras 400, and the virtual cameras 400 may be arranged according to the information related to the direction and the distance.

The information related to information may include an angle formed by the virtual camera 400 and a YZ plane of the point cloud and an angle formed by the virtual camera 400 and an XY plane of the point cloud.

Accordingly, the local true orthoimage deriving unit 320 may photograph the point cloud at preset patch intervals using the plurality of virtual cameras 400 arranged at the set intervals to acquire the local true orthoimages 410 at the set patch intervals.

That is, the virtual cameras 400 may be arranged at preset intervals at positions perpendicular to the point cloud.

Referring to FIG. 5, each virtual camera 400 may vertically photograph a relatively very small area (point cloud) at a position where the virtual camera 400 itself is arranged.

Since each virtual camera 400 photographs each area, the plurality of virtual cameras 400 may be arranged as shown in FIG. 6.

Referring to FIG. 6, the plurality of virtual cameras 400 arranged on the point cloud may photograph corresponding areas on the same plane.

Accordingly, a number of a plurality of local true orthoimages 410 that correspond to a number of virtual cameras 400 may be acquired.

In FIG. 7, four local true orthoimages 410 captured by four virtual cameras 400 are shown.

The true orthoimage generation unit 330 may generate a true orthoimage 500 using the plurality of local true orthoimages 410.

That is, the true orthoimage generation unit 330 may finally generate a true orthoimage 500 by connecting the plurality of local true orthoimages 410 at set patch intervals.

In FIG. 8, one true orthoimage 500 generated by connecting a plurality of local true orthoimages 410 is shown.

In the present embodiment, in order to aid understanding of the present embodiment, the point cloud acquisition unit 310, the local true orthoimage deriving unit 320, and the true orthoimage generation unit 330 are described as separate components within the processor 300, but in some cases, the processor 300 may be implemented as a component in which the respective sub-components are integrally operated.

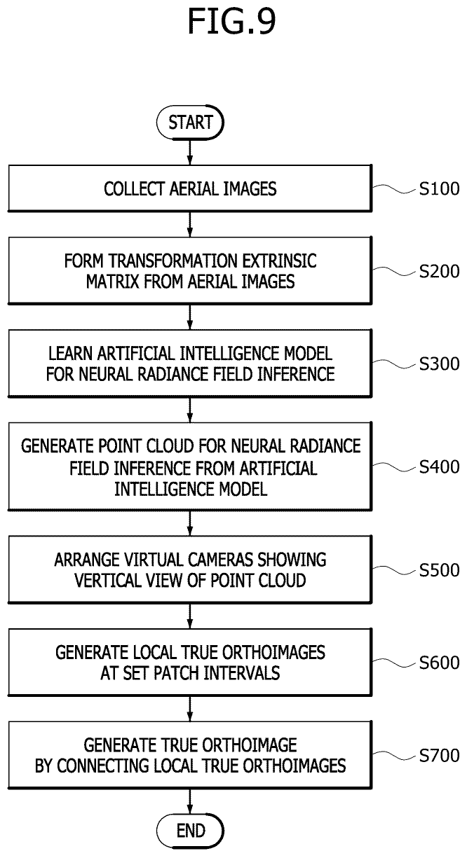

Hereinafter, a true orthoimage generation method according to an embodiment of the present invention will be described with reference to FIG. 9.

FIG. 9 is a flowchart of a true orthoimage generation method according to an embodiment of the present invention.

Referring to FIG. 9, an aerial image collection unit 100 may collect aerial images (S100).

The aerial images may be superimposed images acquired by photographing the same ground surface area.

The aerial image collection unit 100 may photograph or collect aerial images in real time from a photographing device, or collect aerial images through a communication network via a database unit or a data storage unit for storing aerial images.

The processor 300 may form a transformation extrinsic matrix that transforms points within a camera from each aerial image into a world coordinate system (S200).

The processor 300 may learn an artificial intelligence model for neural radiance field inference when the aerial images are collected (S300).

In this case, the artificial intelligence model may learn the transformation extrinsic matrix and the aerial images every time the aerial images are collected and output a point cloud for neural radiance field inference.

Further, the processor 300 may perform view synthesis on the point cloud generated through the artificial intelligence model to acquire a point cloud that allows the ground surface area to be viewed at multiple locations and in multiple directions (S400).

In the processor 300, virtual cameras 400 showing a vertical view of the point cloud may be arranged (S500).

Here, the virtual camera 400 may generate view images showing a vertical view of the point cloud.

In this case, the processor 300 may arrange the virtual cameras 400 to be coplanar at set intervals.

Information related to direction and distance about the point cloud may be set for the virtual cameras 400, and the virtual cameras 400 may be arranged according to the information related to the direction and the distance.

The processor 300 may photograph the point cloud at set patch intervals using a plurality of virtual cameras 400 arranged at set intervals to acquire local true orthoimages 410 at set patch interval (S600).

In this case, a number of a plurality of local true orthoimages 410 that correspond to a number of virtual cameras 400 may be acquired.

As the plurality of local true orthoimages 410 are generated, the processor 300 may generate a true orthoimage 500 using the plurality of local true orthoimages 410 (S700). That is, the processor 300 may finally generate a true orthoimage 500 by connecting the plurality of local true orthoimages 410 at set patch intervals (S700).

As described above, the true orthoimage generation apparatus and method according to the embodiments of the present invention can acquire a point cloud from a plurality of superimposed aerial images, derive local true orthoimages 410 showing a vertical view of the point cloud, and then generate a true orthoimage 500 by connecting the local true orthoimages 410.

A true orthoimage generation apparatus and method according to one aspect of the present invention can acquire a point cloud from a plurality of superimposed aerial images, derive local true orthoimages showing a vertical view of the point cloud, and then generate a true orthoimage by connecting the local true orthoimages.

What is claimed is:

1. A true orthoimage generation apparatus comprising:
a processor; and
a memory configured to store instructions executed by the processor,
wherein the processor acquires a point cloud from a plurality of superimposed aerial images through neural radiance field inference, derives a plurality of local true orthoimages showing a vertical view of the point cloud, and then generates a true orthoimage using the local true orthoimages.

2. The true orthoimage generation apparatus of claim 1, wherein the processor derives the point cloud using an artificial intelligence model for the neural radiance field inference and performs view synthesis on the point cloud to be viewed at continuous angles.

3. The true orthoimage generation apparatus of claim 2, wherein the artificial intelligence model learns the superimposed aerial images and a transformation extrinsic matrix that transforms points within a camera from the superimposed aerial images into a world coordinate system.

4. The true orthoimage generation apparatus of claim 1, wherein the processor arranges a plurality of virtual cameras that photograph the point cloud and acquires the local true orthoimages for each virtual camera.

5. The true orthoimage generation apparatus of claim 4, wherein the virtual cameras are arranged at preset intervals at positions perpendicular to the point cloud.

6. The true orthoimage generation apparatus of claim 4, wherein information related to direction and distance about the point cloud are set for the virtual camera.

7. The true orthoimage generation apparatus of claim 6, wherein the information related to direction includes at least one of an angle formed by the virtual camera and a YZ plane of the point cloud and an angle formed by the virtual camera and an XY plane of the point cloud.

8. The true orthoimage generation apparatus of claim 4, wherein the processor generates the local true orthoimages at set patch intervals using the virtual cameras and acquires the true orthoimage by connecting the local true orthoimages generated at the set patch intervals.

9. A true orthoimage generation method comprising:
acquiring, by a processor, a point cloud from a plurality of superimposed aerial images through neural radiance field inference;
deriving, by the processor, a plurality of local true orthoimages showing a vertical view of the point cloud; and
generating, by the processor, a true orthoimage using the local true orthoimages.

10. The true orthoimage generation method of claim 9, wherein, in the acquiring of the point cloud through the neural radiance field inference, the processor derives the point cloud using an artificial intelligence model for the neural radiance field inference and performs view synthesis on the point cloud to be viewed at continuous angles.

11. The true orthoimage generation method of claim 10, wherein the artificial intelligence model learns the superimposed aerial images and a transformation extrinsic matrix that transforms points within a camera from the superimposed aerial images into a world coordinate system.

12. The true orthoimage generation method of claim 9, wherein, in the deriving of the plurality of local true orthoimages, the processor arranges a plurality of virtual cameras that photograph the point cloud and acquires the local true orthoimages for each virtual camera.

13. The true orthoimage generation method of claim 12, wherein the virtual cameras are arranged at preset intervals at positions perpendicular to the point cloud.

14. The true orthoimage generation method of claim 12, wherein information related to direction and distance about the point cloud are set for the virtual camera.

15. The true orthoimage generation method of claim 14, wherein the information related to direction includes at least one of an angle formed by the virtual camera and a YZ plane of the point cloud and an angle formed by the virtual camera and an XY plane of the point cloud.

16. The true orthoimage generation method of claim 12, wherein, in the generating of the true orthoimages, the processor generates the local true orthoimages at set patch intervals using the virtual cameras and acquires the true orthoimage by connecting the local true orthoimages generated at the set patch intervals.
